(19) United States
(12) Patent Application Publication
(10) Pub. No.: US 2026/0156640 A1
(43) Pub. Date: Jun. 4, 2026

(54) CONCURRENT MULTI-PANEL TRANSMISSIONS

(71) Applicant: QUALCOMM INCORPORATED, San Diego, CA (US)

(72) Inventors: Fang Yuan, Beijing (CN); Wooseok Nam, San Diego, CA (US); Tao Luo, San Diego, CA (US)

(21) Appl. No.: 18/686,284

(22) PCT Filed: Oct. 30, 2021
(86) PCT No.: PCT/CN2021/127772

§ 371 Date: Feb. 23, 2024

(51) Int. Cl. H04W 72/1268; H04W 72/044

(52) U.S. Cl. CPC H04W 72/1268; H04W 72/044

(57) ABSTRACT

Methods, systems, and devices for wireless communications are described. A UE may transmit a capability message that indicates a number of layers supported by the UE for concurrent multi-panel transmissions using a set of antenna panels of the UE. The UE may receive control messages that indicate scheduling information for multiple uplink messages associated with respective transmission configuration indication (TCI) states for concurrent multi-panel transmissions using the set of antenna panels in accordance with the number of layers supported by the UE. In some examples, the multiple uplink messages may be scheduled in at least partially overlapping time resources. The UE may transmit, based on receiving the scheduling information, the multiple uplink messages using the set of antenna panels of the UE in accordance with the respective TCI states and the number of layers supported by the UE for concurrent multi-panel transmissions.

### CROSS REFERENCE

The present Application is a 371 national stage filing of International PCT Application No. PCT/CN2021/127772 by Yuan et al. entitled “CONCURRENT MULTI-PANEL TRANSMISSIONS,” filed Oct. 30, 2021, which is assigned to the assignee hereof, and which is expressly incorporated by reference in its entirety herein.

### FIELD OF TECHNOLOGY

The following relates to wireless communications, including concurrent multi-panel transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support concurrent multi-panel transmissions. Generally, the described techniques may enable flexible multiple-input/multiple-output (MIMO) layer support for a user equipment (UE) that has different antenna panels available for transmission of multiple uplink messages. For example, a UE may transmit a UE capability to a network device (e.g., a base station, gNodeB, etc.) that may indicate a number of MIMO layers supported for multi-panel transmissions in which at least two uplink messages at least partially overlap in time or frequency. In some cases, the UE may indicate a maximum number of MIMO layers supported for each antenna panel at the UE (e.g., on a per antenna panel basis such that each antenna panel supports a different number of layers) or may indicate a total number of MIMO layers supported across all antenna panels at the UE. Further, the UE may indicate a capability to support simultaneous transmission of different channel types using different antenna panels in a multi-panel operation, such as multiple uplink messages associated with respective transmission configuration indication (TCI) states. For example, the UE may indicate to the base station support for simultaneous transmission of a physical uplink shared channel (PUSCH) using a first antenna panel and transmission of a second PUSCH, a physical uplink control channel (PUCCH), or a sounding reference signal (SRS) using a second antenna panel.

A method for wireless communications at a user equipment (UE) is described. The method may include transmitting a capability message that indicates a number of layers supported by the UE for concurrent multi-panel transmissions using a set of multiple antenna panels of the UE, receiving one or more control messages that indicate scheduling information for multiple uplink messages for transmission by the UE using the set of multiple antenna panels of the UE in accordance with the number of layers supported by the UE for concurrent multi-panel transmissions, and transmitting, based on the scheduling information, the multiple uplink messages using the set of multiple antenna panels of the UE in accordance with the number of layers supported by the UE for concurrent multi-panel transmissions.

An apparatus for wireless communications at a UE is described. The apparatus may include a processor, memory coupled with the processor, and instructions stored in the memory. The instructions may be executable by the processor to cause the apparatus to transmit a capability message that indicates a number of layers supported by the UE for concurrent multi-panel transmissions using a set of multiple antenna panels of the UE, receive one or more control messages that indicate scheduling information for multiple uplink messages for transmission by the UE using the set of multiple antenna panels of the UE in accordance with the number of layers supported by the UE for concurrent multi-panel transmissions, and transmit, based on the scheduling information, the multiple uplink messages using the set of multiple antenna panels of the UE in accordance with the number of layers supported by the UE for concurrent multi-panel transmissions.

Another apparatus for wireless communications at a UE is described. The apparatus may include means for transmitting a capability message that indicates a number of layers supported by the UE for concurrent multi-panel transmissions using a set of multiple antenna panels of the UE, means for receiving one or more control messages that indicate scheduling information for multiple uplink messages for transmission by the UE using the set of multiple antenna panels of the UE in accordance with the number of layers supported by the UE for concurrent multi-panel transmissions, and means for transmitting, based on the scheduling information, the multiple uplink messages using the set of multiple antenna panels of the UE in accordance with the number of layers supported by the UE for concurrent multi-panel transmissions.

A non-transitory computer-readable medium storing code for wireless communications at a UE is described. The code may include instructions executable by a processor to transmit a capability message that indicates a number of layers supported by the UE for concurrent multi-panel transmissions using a set of multiple antenna panels of the UE, receive one or more control messages that indicate scheduling information for multiple uplink messages for transmission by the UE using the set of multiple antenna panels of the UE in accordance with the number of layers supported by the UE for concurrent multi-panel transmissions, and transmit, based on the scheduling information, the multiple uplink messages using the set of multiple antenna panels of the UE in accordance with the number of layers supported by the UE for concurrent multi-panel transmissions.

In some examples of the method, apparatuses, and non-transitory computer-readable medium described herein, transmitting the multiple uplink messages may include operations, features, means, or instructions for transmitting, based on the scheduling information, a first uplink message of the multiple uplink messages using a first antenna panel of the set of multiple antenna panels of the UE in accordance with a first respective number of layers for the first antenna panel and transmitting, based on the scheduling information, a second uplink message of the multiple uplink message using a second antenna panel of the set of multiple antenna panels of the UE in accordance with a second respective number of layers for the second antenna panel.

In some examples of the method, apparatuses, and non-transitory computer-readable medium described herein, transmitting the capability message may include operations, features, means, or instructions for transmitting one or more indications of a respective number of layers supported per antenna panel of the set of multiple antenna panels of the UE.

In some examples of the method, apparatuses, and non-transitory computer-readable medium described herein, a first antenna panel of the set of multiple antenna panels supports a first number of layers and a second antenna panel of the set of multiple antenna panels supports a second number of layers different from the first number of layers.

In some examples of the method, apparatuses, and non-transitory computer-readable medium described herein, transmitting the multiple uplink messages may include operations, features, means, or instructions for transmitting, based on the scheduling information, a first uplink message of the multiple uplink messages using a first antenna panel of the set of multiple antenna panels of the UE in accordance with the number of layers and transmitting, based on the scheduling information, a second uplink message of the multiple uplink messages using a second antenna panel of the set of multiple antenna panels of the UE in accordance with the number of layers.

In some examples of the method, apparatuses, and non-transitory computer-readable medium described herein, transmitting the capability message may include operations, features, means, or instructions for transmitting one or more indications of a total number of layers supported across all of the set of multiple antenna panels of the UE.

In some examples of the method, apparatuses, and non-transitory computer-readable medium described herein, transmitting the multiple uplink messages may include operations, features, means, or instructions for transmitting the multiple uplink messages using at least two different antenna panels of the set of multiple antenna panels of the UE according to one of a spatial division multiplexing scheme, a frequency division multiplexing scheme, or a single frequency network scheme.

In some examples of the method, apparatuses, and non-transitory computer-readable medium described herein, transmitting the multiple uplink messages may include operations, features, means, or instructions for transmitting the multiple uplink messages using at least two different antenna panels of the set of multiple antenna panels of the UE, where a first uplink message of the multiple uplink messages at least partially overlaps in time, frequency, or both with a second uplink message of the multiple uplink messages.

In some examples of the method, apparatuses, and non-transitory computer-readable medium described herein, receiving the one or more control messages may include operations, features, means, or instructions for receiving, from a first transmission reception point, a first control message indicating first scheduling information for a first uplink message of the multiple uplink messages and receiving, from a second transmission reception point, a second control message indicating second scheduling information for a second uplink message of the multiple uplink messages, where the second uplink message may be scheduled via resources that at least partially overlap in time or frequency with the first uplink message.

In some examples of the method, apparatuses, and non-transitory computer-readable medium described herein, a first antenna panel of the set of multiple antenna panels may be associated with a first transmit precoding matrix index (TPMI), a first SRS resource indicator (SRI), and a first transmission configuration indication (TCI) state and a second antenna panel of the set of multiple antenna panels may be associated with a second TPMI, a second SRI, and a second TCI.

A method for wireless communications at a UE is described. The method may include transmitting a capability message that indicates UE support for concurrent multi-panel uplink transmissions using a set of multiple antenna panels of the UE, receiving one or more control messages that indicate scheduling information for a first uplink message and a second uplink message for transmission by the UE using the set of multiple antenna panels of the UE, each of the first uplink message and the second uplink message associated with a respective transmission configuration indication state, where the first uplink message and the second uplink message are scheduled in at least partially overlapping time resources, and transmitting, based on the scheduling information and via the partially overlapping time resources, the first and second uplink messages using the set of multiple antenna panels of the UE in accordance with the respective transmission configuration indication states.

An apparatus for wireless communications at a UE is described. The apparatus may include a processor, memory coupled with the processor, and instructions stored in the memory. The instructions may be executable by the processor to cause the apparatus to transmit a capability message that indicates UE support for concurrent multi-panel uplink transmissions using a set of multiple antenna panels of the UE, receive one or more control messages that indicate scheduling information for a first uplink message and a second uplink message for transmission by the UE using the set of multiple antenna panels of the UE, each of the first uplink message and the second uplink message associated with a respective transmission configuration indication state, where the first uplink message and the second uplink message are scheduled in at least partially overlapping time resources, and transmit, based on the scheduling information and via the partially overlapping time resources, the first and second uplink messages using the set of multiple antenna panels of the UE in accordance with the respective transmission configuration indication states.

Another apparatus for wireless communications at a UE is described. The apparatus may include means for transmitting a capability message that indicates UE support for concurrent multi-panel uplink transmissions using a set of multiple antenna panels of the UE, means for receiving one or more control messages that indicate scheduling information for a first uplink message and a second uplink message for transmission by the UE using the set of multiple antenna panels of the UE, each of the first uplink message and the second uplink message associated with a respective transmission configuration indication state, where the first uplink message and the second uplink message are scheduled in at least partially overlapping time resources, and means for transmitting, based on the scheduling information and via the partially overlapping time resources, the first and second uplink messages using the set of multiple antenna panels of the UE in accordance with the respective transmission configuration indication states.

A non-transitory computer-readable medium storing code for wireless communications at a UE is described. The code may include instructions executable by a processor to transmit a capability message that indicates UE support for concurrent multi-panel uplink transmissions using a set of multiple antenna panels of the UE, receive one or more control messages that indicate scheduling information for a first uplink message and a second uplink message for transmission by the UE using the set of multiple antenna panels of the UE, each of the first uplink message and the second uplink message associated with a respective transmission configuration indication state, where the first uplink message and the second uplink message are scheduled in at least partially overlapping time resources, and transmit, based on the scheduling information and via the partially overlapping time resources, the first and second uplink messages using the set of multiple antenna panels of the UE in accordance with the respective transmission configuration indication states.

In some examples of the method, apparatuses, and non-transitory computer-readable medium described herein, transmitting the first and second uplink messages may include operations, features, means, or instructions for transmitting, based on the scheduling information and via the partially overlapping time resources, a dynamically scheduled uplink shared channel using a first antenna panel of the set of multiple antenna panels of the UE and a configured grant uplink shared channel using a second antenna panel of the set of multiple antenna panels of the UE in accordance with the respective transmission configuration indication states.

In some examples of the method, apparatuses, and non-transitory computer-readable medium described herein, transmitting the first and second uplink messages may include operations, features, means, or instructions for transmitting, based on the scheduling information and via the partially overlapping time resources, the first uplink message using a first antenna panel of the set of multiple antenna panels of the UE and the second uplink message using a second antenna panel of the set of multiple antenna panels of the UE in accordance with the respective transmission configuration indication states, where the first and second uplink messages may have a same waveform or different waveforms.

In some examples of the method, apparatuses, and non-transitory computer-readable medium described herein, transmitting the first and second uplink messages may include operations, features, means, or instructions for transmitting, based on the scheduling information and via the partially overlapping time resources, an uplink shared channel using a first antenna panel of the set of multiple antenna panels of the UE and an uplink control channel message using a second antenna panel of the set of multiple antenna panels of the UE in accordance with the respective transmission configuration indication states.

In some examples of the method, apparatuses, and non-transitory computer-readable medium described herein, transmitting the first and second uplink messages may include operations, features, means, or instructions for transmitting, based on the scheduling information and via the partially overlapping time resources, a first uplink control channel using a first antenna panel of the set of multiple antenna panels of the UE and a second uplink control channel message using a second antenna panel of the set of multiple antenna panels of the UE in accordance with the respective transmission configuration indication states.

In some examples of the method, apparatuses, and non-transitory computer-readable medium described herein, transmitting the first and second uplink messages may include operations, features, means, or instructions for transmitting, based on the scheduling information and via the partially overlapping time resources, a sounding reference signal using a first antenna panel of the set of multiple antenna panels of the UE and the second uplink message using a second antenna panel of the set of multiple antenna panels of the UE in accordance with the respective transmission configuration indication states, where the second uplink message includes one of an uplink control channel or an uplink shared channel.

### BRIEF DESCRIPTION OF THE DRAWINGS

FIG. 1 illustrates an example of a wireless communications system that supports concurrent multi-panel transmissions in accordance with aspects of the present disclosure.

FIG. 2 illustrates an example of a wireless communications system that supports concurrent multi-panel transmissions in accordance with aspects of the present disclosure.

FIG. 3 illustrates an example of a process flow that supports concurrent multi-panel transmissions in accordance with aspects of the present disclosure.

FIG. 4 illustrates an example of a process flow that supports concurrent multi-panel transmissions in accordance with aspects of the present disclosure.

FIGS. 5 and 6 show block diagrams of devices that support concurrent multi-panel transmissions in accordance with aspects of the present disclosure.

FIG. 7 shows a block diagram of a communications manager that supports concurrent multi-panel transmissions in accordance with aspects of the present disclosure.

FIG. 8 shows a diagram of a system including a device that supports concurrent multi-panel transmissions in accordance with aspects of the present disclosure.

FIGS. 9 through 12 show flowcharts illustrating methods that support concurrent multi-panel transmissions in accordance with aspects of the present disclosure.

### DETAILED DESCRIPTION

In some wireless communications systems, such as multiple-input/multiple-output (MIMO) systems, multiple wireless devices (e.g., a user equipment (UE) and a base station) may communicate such that the UE or the base station, or both, may transmit or receive signaling simultaneously via multiple directional beams. For example, the UE may transmit signaling to the base station via one or more transmit beams and the base station may receive the signaling via multiple receive beams, or vice versa.

In some cases, the UE may indicate to the base station one or more capabilities with respect to MIMO communications. Capabilities may include, for instance, an indication of a number of MIMO layers that the UE can use to transmit or receive transmissions with the base station (e.g., based on the number of antennas at the UE, processing capabilities at the UE, or the like). The number of layers the UE is capable of using may refer to a number of data streams the UE is capable of transmitting in parallel (e.g., a number of physical uplink shared channel (PUSCH) transmissions that at least partially overlap in time). In some examples, the UE may transmit an indication of the maximum number of supportable MIMO layers to the base station for multiple PUSCH transmissions using a codebook precoding (e.g., maxNumberMIMO-LayersCB-PUSCH) or using a non-codebook precoding (e.g., maxNumberMIMO-LayersNonCB-PUSCH).

In some cases, different antenna panels at the UE may be configured to support different numbers of MIMO layers for communications. Traditional techniques may not support such capabilities, much less the reporting of such capabilities by a UE.

According to the techniques described herein, a UE may transmit a capability message to the base station indicating support for simultaneous transmission of multiple uplink messages in a multi-panel operation. For example, the UE may transmit a first uplink message using a first antenna panel at the UE and a second uplink message using a second antenna panel at the UE in accordance with the number of MIMO layers supported by the UE for multi-panel transmissions. In some examples, the UE may indicate the number of MIMO layers supported on a per panel basis to the base station. In some examples, the UE may include the field maxNumberMIMO-LayersCB-PUSCH-per-panel in the capability message which may indicate the maximum number of MIMO layers supported per panel at the UE using codebook precoding. In some examples, the UE may include the field maxNumberMIMO-LayersNonCB-PUSCH-per-panel in the capability message which may indicate the maximum number of MIMO layers supported per panel at the UE using non-codebook precoding.

Additionally or alternatively, the UE may indicate in the capability message the total maximum number of MIMO layers supported across the set of antenna panels at the UE. In some examples, the value may be an aggregate of the number of MIMO layers supported at each antenna panel of the UE. In some examples, this value may be a default value preconfigured at the UE or configured by the network. in some examples, the UE may include the field maxNumberMIMO-LayersCB-PUSCH-across-panel in the capability message which may indicate the maximum number of MIMO layers supported across the set of antenna panels at the UE using codebook precoding. In some examples, the UE may include the field maxNumberMIMO-LayersNonCB-PUSCH-across-panel in the capability message which may indicate the maximum number of MIMO layers supported across the set of antenna panels at the UE using non-codebook precoding.

Additionally or alternatively, the UE indicate in the capability message support for simultaneous transmission in multi-panel operation. For example, the UE capability may indicate to the base station support of transmission of multiple uplink messages using different antenna panels that may be scheduled over resources that at least partially overlap in time. In some cases, the UE may indicate a capability for simultaneous or concurrent transmission of two uplink messages on two antenna panels using the same channel type (e.g., two shared channels or two control channels) using the same or different waveforms. In some cases, the UE may indicate a capability for simultaneous or concurrent transmission of two uplink messages on two antenna panels using different channel types (e.g., concurrent transmission of a shared channel and a control channel, concurrent transmission of a control channel and a reference signal, or concurrent transmission of a shared channel and an reference signal).

Aspects of the disclosure are initially described in the context of wireless communications systems. Aspects of the disclosure are further illustrated by process flows. Aspects of the disclosure are further illustrated by and described with reference to apparatus diagrams, system diagrams, and flowcharts that relate to concurrent multi-panel transmissions.

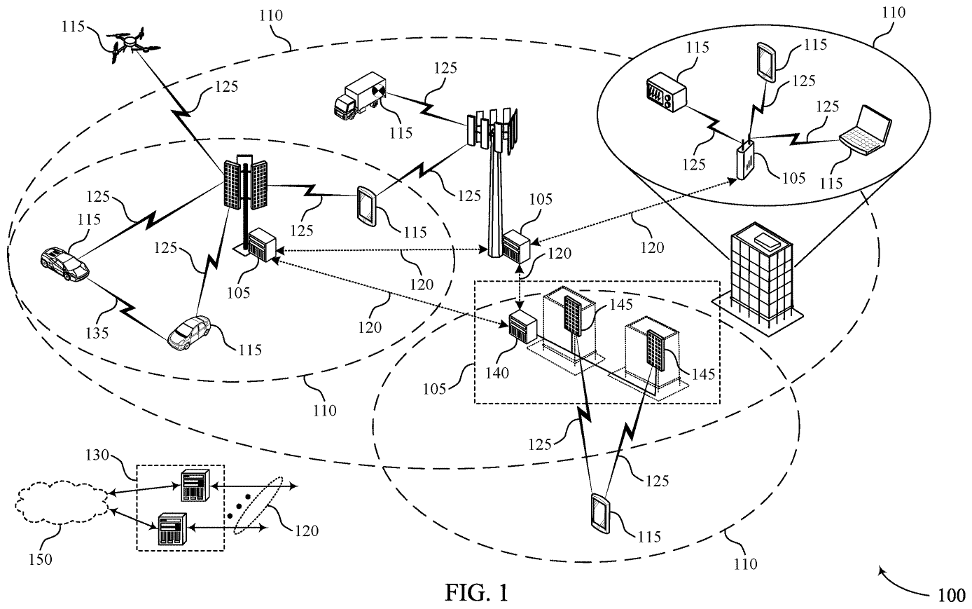

FIG. 1 illustrates an example of a wireless communications system 100 that supports concurrent multi-panel transmissions in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or another network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or another interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1: M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHZ industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, the wireless communications system 100 may enable flexible MIMO layer support for a UE 115 that has different antenna panels available for transmission of multiple uplink messages. For example, a UE 115 may transmit a UE capability that indicates a number of MIMO layers supported for multi-panel transmissions in which at least two uplink messages at least partially overlap in time or frequency. In some cases, the UE 115 may indicate a maximum number of MIMO layers supported for each antenna panel at the UE 115 (e.g., on a per antenna panel basis such that each antenna panel supports a different number of layers) or may indicate a total number of MIMO layers supported across all antenna panels at the UE 115. Further, the UE 115 may indicate a capability to support simultaneous transmission of different channel types using different antenna panels in a multi-panel operation, such as multiple uplink messages associated with respective TCI states. For example, the UE 115 may indicate to the base station support for simultaneous transmission of a PUSCH using a first antenna panel and transmission of a PUCCH, a second PUSCH, or an SRS using a second antenna panel.

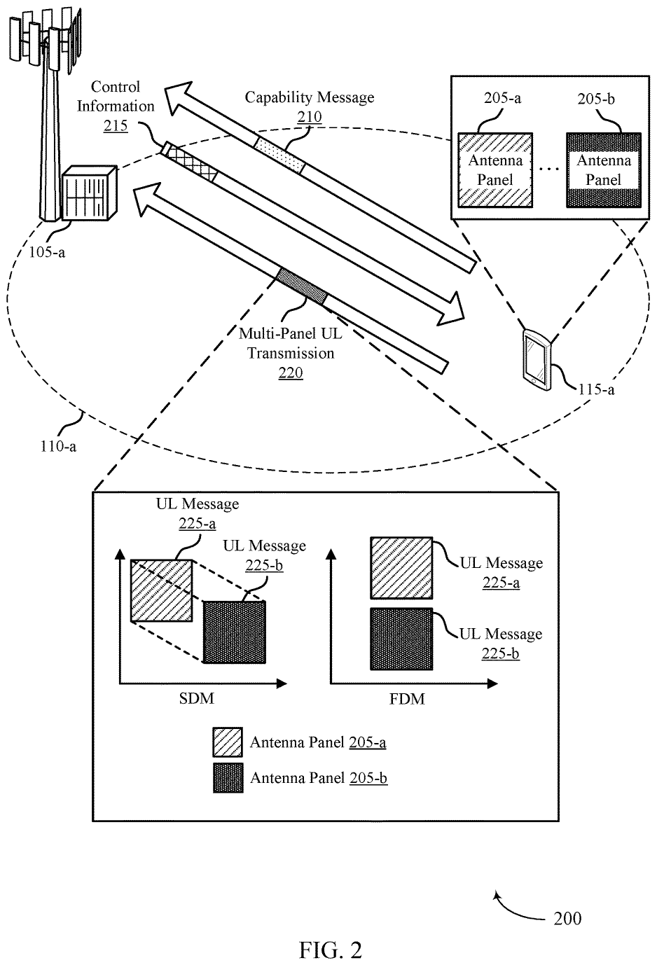

FIG. 2 illustrates an example of a wireless communications system 200 that supports concurrent multi-panel transmissions in accordance with aspects of the present disclosure. The wireless communication systems 200 may implement or be implemented by one or more aspects of the wireless communications system 100. For example, the wireless communications systems 200 may include a UE 115-a and a base station 105-a which may be respective examples of a UE 115 and a base station 105 as described with reference to FIG. 1. In some examples, the UE 115-a may operate in accordance with MIMO communications with the base station 105-a. Specifically, the UE 115-a may benefit from indicating a capability message 210 to the base station 105-a that specifies a number of MIMO layers supported by the antenna panels 205 and the type of uplink messages that may be used during concurrent multi-panel uplink transmissions. It should be noted that, while examples are discussed below, any number of devices and device types may be used to accomplish implementations described in the present disclosure.

In the wireless communications system 200, the UE 115-a and the base station 105-a may be located in a geographic area 110-a, which may correspond to an environment in which the multiple wireless devices may transmit and receive wireless communications. In some examples, a UE 115-a may include one or more antenna panels that may be used for such wireless communications. For instance, the UE 115-a may include at least an antenna panel 205-a and an antenna panel 205-b. In some examples, each of the multiple antenna panels 205 at the UE 115-a may be associated respectively with any of transmit precoding matrix index (TPMI), a sounding reference signal (SRS) resource indicator (SRI), a close loop index for power control, a CORESET pool index for DCI reception, or a transmission configuration indication (TCI) state. While two antenna panels 205 are illustrated in FIG. 2, a person skilled in the art would appreciate that the UE 115-a may include any number of antenna panels 205 that may be used for concurrent multi-panel communications.

In some cases, the antenna panels 205 at the UE 115-a may be configured to handle a number of MIMO layers for wireless communications on a per antenna panel 205 basis (e.g., based on processing capabilities at the UE 115-a, the type of messages handled by an antenna panel 205, or the like). For example, the antenna panel 205-a may be used more frequently than the antenna panel 205-b, and as such the UE 115-a may configure the antenna panel 205-a with a lower MIMO layer capability in the interest of saving power at the UE 115-a. In some cases, the UE 115-a may configure a maximum aggregate number of MIMO layers used across a set of antenna panels 205. For example, if the maximum aggregate number of MIMO layers is four, then the combined number of MIMO layers used by the antenna panel 205-a and the antenna panel 205-a may be less than or equal to four.

According to the techniques described herein, the UE 115-a may transmit a capability message 210 to the base station 105-a that indicates a number of MIMO layers supported by the UE 115-a for concurrent multi-panel transmissions using the multiple antenna panels 205. In some cases, the UE 115-a may include in the capability message 210 the maximum supportable MIMO layers for each antenna panel 205. For instance, the capability message 210 may include one or more indications of a respective number of MIMO layers supported at each antenna panel 205 such that the antenna panel 205-a may support a first maximum number of MIMO layers and the antenna panel 205-b may support a second maximum number of MIMO layers. In some examples, the indication may be a field in the capability message 210 (e.g., maxNumberMIMO-LayersCB-PUSCH-per-panel) that may indicate the maximum number of MIMO layers supported per antenna panel 205 at the UE 115-a in cases of codebook precoding. In some examples, the indication may be a field in the capability message 210 (e.g., maxNumberMIMO-LayersNonCB-PUSCH-per-panel) that may indicate the maximum number of MIMO layers supported per antenna panel 205 at the UE 115-a in cases of non-codebook precoding.

Additionally or alternatively, the UE 115-a may include in the capability message 210 an indication of the maximum supportable MIMO layers across all antenna panels 205. For instance, the capability message 210 may include one or more indications of a total number of MIMO layers supported across all of the plurality of antenna panels 205 of the UE 115-a. In some examples, the indication may be a field in the capability message 210 (e.g., maxNumberMIMO-LayersCB-PUSCH-across-panel) that may indicate the maximum number of MIMO layers supported across all antenna panels 205 at the UE 115-a in cases of codebook precoding. In some examples, the indication may be a field in the capability message 210 (e.g., maxNumberMIMO-LayersNonCB-PUSCH-across-panel) that may indicate the maximum number of MIMO layers supported across all antenna panels 205 at the UE 115-a in cases of non-codebook precoding. The UE 115-a may have an associated limited capability on the total number of MIMO layer for all panels.

As such, the UE 115-a may receive, from the base station 105-a, control information 215 that may be associated with the capability message 210. For example, the control information 215 may include one or more control messages that indicate scheduling information for multiple uplink messages 225 (e.g., an uplink message 225-a and an uplink message 225-b) for transmission by the UE 115-a using the multiple antenna panels 205 (e.g., the antenna panel 205-a and the antenna panel 205-b respectively) in accordance with the number of MIMO layers supported by the UE 115-a for concurrent multi-panel transmissions.

Based on receiving the scheduling information from the base station 105-a, the UE 115-a transmit a multi-panel uplink transmission 220 in accordance with the communication resources indicated in the scheduling information and in accordance with the MIMO layer capability indicated in the capability message 210. For example, as illustrated in FIG. 2 the UE 115-a may concurrently transmit the first uplink message 225-a using the antenna panel 205-a and the second uplink message 225-b using the antenna panel 205-b.

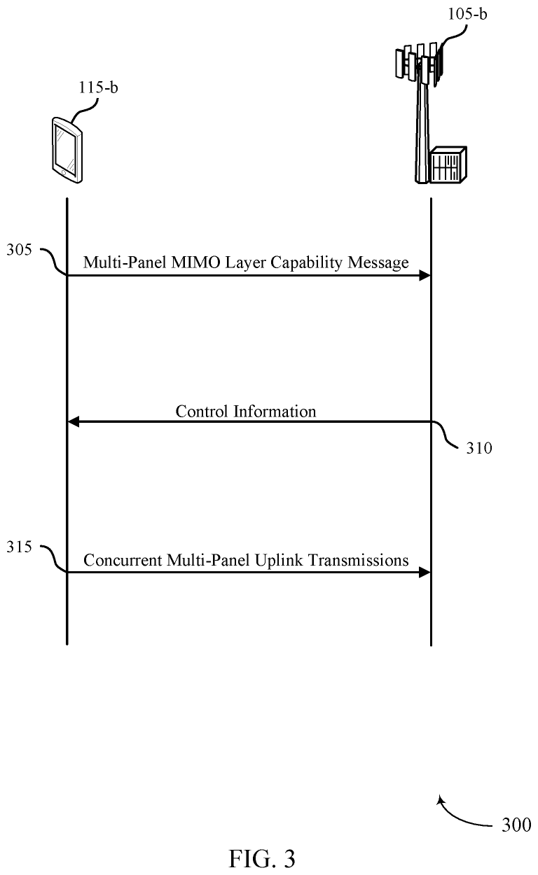

In some implementations, the UE 115-a may perform the multi-panel uplink transmission 220 using one of several transmission schemes. In some examples, the base station 105-a may schedule the UE 115-a for multiple concurrent uplink messages 225 using a spatial division multiplexing (SDM) scheme in which the uplink message 225-a and the uplink message 225-b share at least partially overlapping time-frequency resources and are transmitted using different panels (e.g., antenna panel 205-a and antenna panel 205-b respectively) in different spatial directions. In some examples, the base station 105-a may schedule the UE 115-a for multiple concurrent uplink messages 225 using a frequency division multiplexing (FDM) scheme in which the uplink message 225-a and the uplink message 225-b share at least partially overlapping time resources and are transmitted using different panels (e.g., antenna panel 205-a and antenna panel 205-b, respectively) using different frequency resources. In some examples, the base station 105-a may schedule the UE 115-a for the multiple concurrent uplink messages 225 using a single frequency network (SFN) scheme, in which the uplink message 225-a and the uplink message 225-b may be the same message transmitted via multiple antenna panels 205 (e.g., antenna panel 205-a and antenna panel 205-b) using the same time-frequency resources. As such, based on the uplink message 225 scheduled for the UE 115-a 225 in accordance with an SDM, FDM, or SFN scheme, among other, the uplink message 225-a and the uplink message 225-b may be scheduled for transmission using different antenna panels 205 having at least partially overlapping time or frequency resources. For example, the UE 115-a may participate in a multi-downlink control information (DCI) and multi-transmission/reception point (TRP) operation with one or more base stations 105-a or TRPs supports by base station 105-a, such that if the UE 115-a indicates a maximum number of MIMO layers across all antenna panels 205, then the receiving base station 105-a may interpret the indication as the maximum number of MIMO layers across concurrent uplink messages 225 if the uplink messages 225 share at least one resource element that overlaps in time. Further discussion of UE 115-a support for a number of MIMO layers for concurrent multi-panel transmissions is described herein, including with reference to FIG. 3.

Additionally or alternatively, the UE 115-a may include in the capability message 210 support for supporting concurrent multi-panel uplink transmissions using multiple antenna panels 205 and various uplink channel types. For instance, UE 115-a may support concurrent uplink transmission of a first uplink message associated with a first beam (i.e., spatial transmit filter, or transmission configuration indicator (TCI) state) and a second uplink message associated with a second beam. In some examples, each of the first and second uplink message may be transmitted using a respective antenna panel 205 (e.g., first uplink message may be transmitted using antenna panel 205-a and second uplink message may be transmitted using antenna panel 205-b).

In some examples, the capability message 210 may indicate capability at the UE 115-a for supporting concurrent transmission of a first PUSCH using the antenna panel 205-a and a second PUSCH using the antenna panel 205-b. In such examples, the first and second PUSCHs may be examples of dynamically scheduled PUSCHs, configured grant based PUSCHs, or a combination thereof. The first and second PUSCHs may also have the same waveform or different waveforms. For example, the first PUSCH may be of a discrete Fourier Transform (DFT) spread orthogonal frequency-division multiplexing (OFDM) while the second PUSCH may be of a cyclic prefix (CP) OFDM.

In some examples, the capability message 210 may indicate capability at the UE 115-a for supporting concurrent transmission of a first PUSCH using the antenna panel 205-a and a second physical uplink control channel (PUCCH) using the antenna panel 205-b. The capability message 210 may also indicate that the first PUSCH and the second PUCCH can have the same waveform or different waveforms. For example, the first PUSCH may be of a DFT-spread OFDM while the second PUCCH may be of a CP-OFDM or Vice Versa.

In some examples, the capability message 210 may indicate capability at the UE 115-a for supporting concurrent transmission of a first PUCCH using the antenna panel 205-a and a second PUCCH using the antenna panel 205-b such that the first and second PUCCH have share overlapping time resources.

In some examples, the capability message 210 may indicate capability at the UE 115-a for supporting concurrent transmission where at least one of the transmissions is an example of a SRS. For example, the capability message 210 may indicate capability for supporting concurrent transmission of a first physical uplink channel (e.g., a PUSCH or a PUCCH) using the antenna panel 205-a and a second SRS using the antenna panel 205-b.

Based on the UE 115-a transmitting the capability message 210, indicating concurrent multi-panel transmissions of one or more message types, the UE 115-a may receive control information 215 that may be associated with the capability message 210. For example, the control information 215 may include one or more control messages that indicate scheduling information for a first uplink message 225-a and a second uplink message 225-b for transmission by the UE 115-a using the antenna panel 205-a and the antenna panel 205-b respectively. In some cases, the first uplink message 225-a and the second uplink message 225-b may also be associated with respective TCI states.

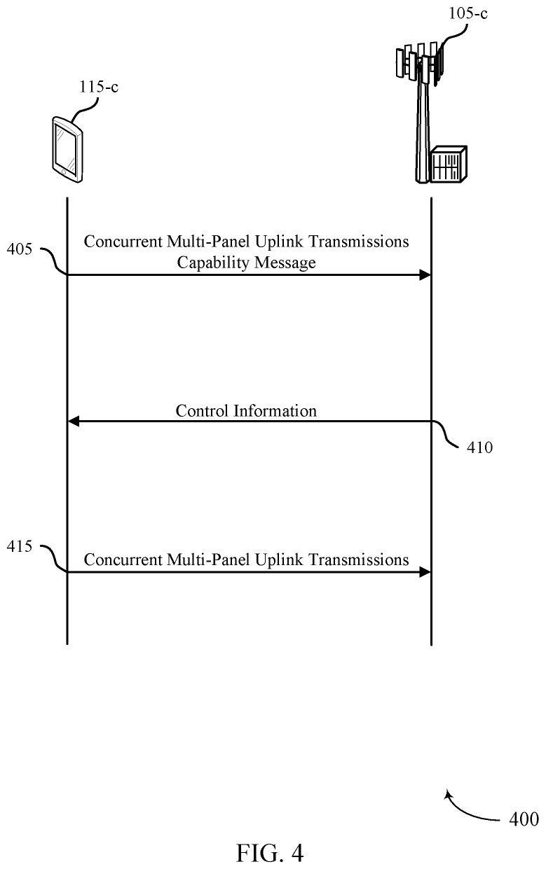

As such, the UE 115-a may schedule the multi-panel uplink transmission 220 to the base station 105-a in accordance with the capability message 210 which may indicate the message type for the uplink message 225-a and the uplink message 225-b (e.g., PUSCH, PUCCH, or SRS) and in accordance with the scheduling information which may indicate the partially overlapping time resources the UE 115-a may use to perform the multi-panel uplink transmission 220. The UE 115-a may determine to transmit the multi-panel uplink transmission 220 using the SDM scheme, the FDM scheme, or the SFN scheme based on a configuration of the network, a configuration at the UE 115-a, the physical environment of the geographic location 110-a, or a combination thereof. Further discussion concurrent multi-panel transmissions using various uplink message types is described herein, including with reference to FIG. 4.

FIG. 3 illustrates an example of a process flow 300 that supports concurrent multi-panel transmissions in accordance with aspects of the present disclosure. In some examples, process flow 300 may implement aspects of wireless communications system 100, wireless communications system 200, or a combination thereof. Process flow 300 includes a UE 115-b and a base station 105-b, which may be respective examples of a UE 115-b and a base station 105 as described with reference to FIGS. 1 and 2. Alternative examples of the following may be implemented, where some steps are performed in a different order than described or are not performed at all. In some cases, steps may include additional features not mentioned below, or further steps may be added. In addition, while process flow 300 shows processes between a single base station 105-b and UE 115-b, it should be understood that these processes may occur between any number of network devices.

At 305, the UE 115-b may transmit a capability message that indicates a number of MIMO layers supported by the UE 115-b for concurrent multi-panel transmissions using a set of antenna panels of the UE 115-b. In some examples, each antenna panel of the set of antenna panels may be associated with a TPMI, an SRI, and a TCI state. In some cases, the capability message may include one or more indications of a respective number of MIMO layers supported per antenna panel of the set of antenna panels of the UE 115-b. For example, a first antenna panel of the set of antenna panels may support a first number of MIMO layers and a second antenna panel of the set of antenna panels may support a second number of MIMO layers that may be different from the first number of MIMO layers. In some cases, the capability message may include one or more indications of a total number of MIMO layers supported across all of the antenna panels of the set of antenna panels.

At 310, the UE 115-b may receive, from the base station 105-b, control information associated with the capability message. For example, the control information may include one or more control messages that indicate scheduling information for multiple uplink messages for transmission by the UE 115-b using the set of antenna panels of the UE 115-b in accordance with the number of MIMO layers supported by the UE 115-b for concurrent multi-panel transmissions. In some cases, the UE 115-b may receive the one or more control messages from one or more TRPs which may be associated with one or more base stations 105. For example, the UE 115-b may receive from a first TRP, a first control message indicating first scheduling information for a first uplink message of the multiple uplink messages and may receive from a second TRP, a second control message indicating second scheduling information for a second uplink message of the multiple uplink messages such that the second uplink message is scheduled via resources that at least partially overlap in time or frequency with the first uplink message.

At 315, the UE 115-b may transmit, to the base station 105-b based on receiving the scheduling information, the multiple uplink messages using the set of antenna panels of the UE 115-b in accordance with the number of MIMO layers supported by the UE 115-b for concurrent multi-panel transmissions. For example, if the UE 115-b indicated in the capability message respective supported MIMO layers for each antenna panel of the set of antenna panels, the UE 115-b may transmit a first uplink message using a first antenna panel of the set of antenna panels of the UE 115-b in accordance with a first respective number of layers for the first antenna panel and transmit a second uplink message using a second antenna panel of the set of antenna panels of the UE 115-b in accordance with a second respective number of MIMO layers for the second antenna panel. Additionally or alternatively, if the UE 115-b indicated in the capability message a number of MIMO layers supported across all of the antenna panels, the UE 115-b may transmit a first uplink message using a first antenna panel of the set of antenna panels in accordance with the number of MIMO layers and transmit a second uplink message using a second antenna panel of the set of antenna panels in accordance with the number of MIMO layers.

In some examples, the scheduling information may indicate transmission of the multiple uplink messages using overlapping time or frequency resources. As such, the UE 115-b may transmit the multiple uplink messages using at least two different antenna panels of the set of antenna panels of the UE 115-b, such that a first uplink message of the multiple uplink messages at least partially overlaps in time, frequency, or both with a second uplink message of the multiple uplink messages. In some implementations, the UE 115-b may transmit the multiple concurrent uplink messages using at least two different antenna panels of the set of antenna panels of the UE 115-b according to one of an SDM scheme, an FDM scheme, or an SFN scheme.

FIG. 4 illustrates an example of a process flow 400 that supports concurrent multi-panel transmissions in accordance with aspects of the present disclosure. In some examples, process flow 400 may implement aspects of wireless communications system 100, wireless communications system 200, or a combination thereof. Process flow 400 includes a UE 115-c and a base station 105-c, which may be respective examples of a UE 115 and a base station 105 as described with reference to FIGS. 1 and 2. Alternative examples of the following may be implemented, where some steps are performed in a different order than described or are not performed at all. In some cases, steps may include additional features not mentioned below, or further steps may be added. In addition, while process flow 400 shows processes between a single base station 105-c and UE 115-c, it should be understood that these processes may occur between any number of network devices.

At 405, the UE 115-c may transmit a capability message, to the base station 105-c, that indicates UE 115-c support for concurrent multi-panel uplink transmissions using a set of antenna panels of the UE 115-c. In some examples, the capability message may indicate support for current transmission of multiple uplink transmission types. For example, the multiple uplink messages may be examples of PUSCH transmissions, PUCCH transmissions, SRS transmissions, or a combination thereof.

At 410, the UE 115-c may receive, from the base station 105-c, control information associated with the capability message. For example, the control information may include one or more control messages that may indicate scheduling information for a first uplink message and a second uplink message for transmission by the UE 115-c using the set of antenna panels of the UE 115-c, such that each of the first uplink message and the second uplink message may be associated with a respective TCI state. In such examples, the first uplink message and the second uplink message may be scheduled in at least partially overlapping time resources.

At 415, the UE 115-c may transmit to the base station 105-c, based on receiving the scheduling information, the first and second uplink messages using the set of antenna panels of the UE 115-c in accordance with the respective TCI states via the partially overlapping time resources. In some examples, the first uplink message may be a dynamically scheduled PUSCH transmitted using a first antenna panel of the set of antenna panels of the UE 115-c and the second uplink message may be a configured grant PUSCH transmitted using a second antenna panel of the set of antenna panels of the UE 115-c in accordance with the respective TCI states. In some examples, the first uplink message may be a PUSCH transmitted using a first antenna panel of the set of antenna panels of the UE 115-c and the second uplink message may be a PUCCH transmitted using a second antenna panel of the set of antenna panels of the UE 115-c in accordance with the respective TCI states. In some examples, the first uplink message may be a first PUCCH transmitted using a first antenna panel of the set of antenna panels of the UE 115-c and the second uplink message may be a second PUCCH transmitted using a second antenna panel of the set of antenna panels of the UE 115-c in accordance with the respective TCI states. In some examples, the first uplink message may be an SRS transmitted using a first antenna panel of the set of antenna panels of the UE 115-c and the second uplink message may be a an uplink channel (e.g., a PUSCH or a PUCCH) transmitted using a second antenna panel of the set of antenna panels of the UE 115-c in accordance with the respective TCI states. In some examples, the first uplink message and the second uplink message may have a same waveform or different waveforms.

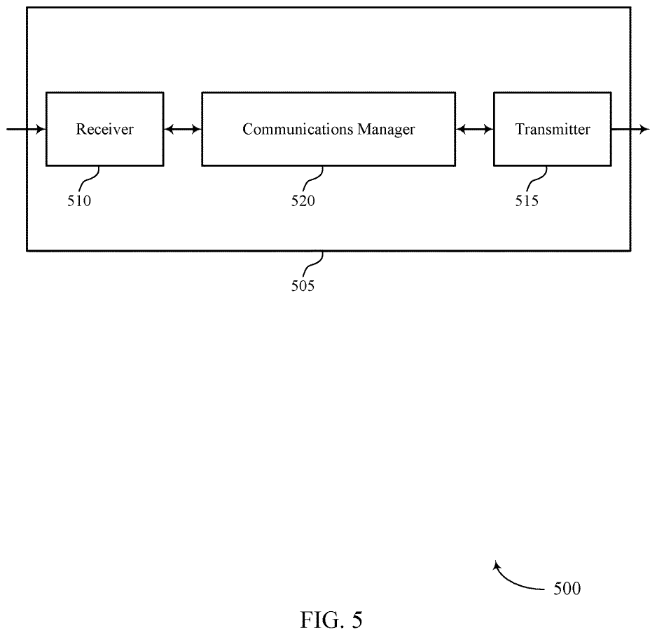

FIG. 5 shows a block diagram 500 of a device 505 that supports concurrent multi-panel transmissions in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to concurrent multi-panel transmissions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to concurrent multi-panel transmissions). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of concurrent multi-panel transmissions as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. For example, the communications manager 520 may be configured as or otherwise support a means for transmitting a capability message that indicates a number of layers supported by the UE for concurrent multi-panel transmissions using a set of multiple antenna panels of the UE. The communications manager 520 may be configured as or otherwise support a means for receiving one or more control messages that indicate scheduling information for multiple uplink messages for transmission by the UE using the set of multiple antenna panels of the UE in accordance with the number of layers supported by the UE for concurrent multi-panel transmissions. The communications manager 520 may be configured as or otherwise support a means for transmitting, based on the scheduling information, the multiple uplink messages using the set of multiple antenna panels of the UE in accordance with the number of layers supported by the UE for concurrent multi-panel transmissions.

Additionally or alternatively, the communications manager 520 may support wireless communications at a UE in accordance with examples as disclosed herein. For example, the communications manager 520 may be configured as or otherwise support a means for transmitting a capability message that indicates UE support for concurrent multi-panel uplink transmissions using a set of multiple antenna panels of the UE. The communications manager 520 may be configured as or otherwise support a means for receiving one or more control messages that indicate scheduling information for a first uplink message and a second uplink message for transmission by the UE using the set of multiple antenna panels of the UE, each of the first uplink message and the second uplink message associated with a respective transmission configuration indication state, where the first uplink message and the second uplink message are scheduled in at least partially overlapping time resources. The communications manager 520 may be configured as or otherwise support a means for transmitting, based on the scheduling information and via the partially overlapping time resources, the first and second uplink messages using the set of multiple antenna panels of the UE in accordance with the respective transmission configuration indication states.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for enabling the device 505 to reduce processing overhead by supporting reliable wireless MIMO communications between UEs 115 and base stations 105. By indicating capability information related to a number of supported MIMO layers across antenna panels and the type of uplink channel types that are capable for use in a concurrent multi-panel uplink transmission, the device 505 may experience an increase device efficiency, a decrease latency, and a reduced processing overhead.

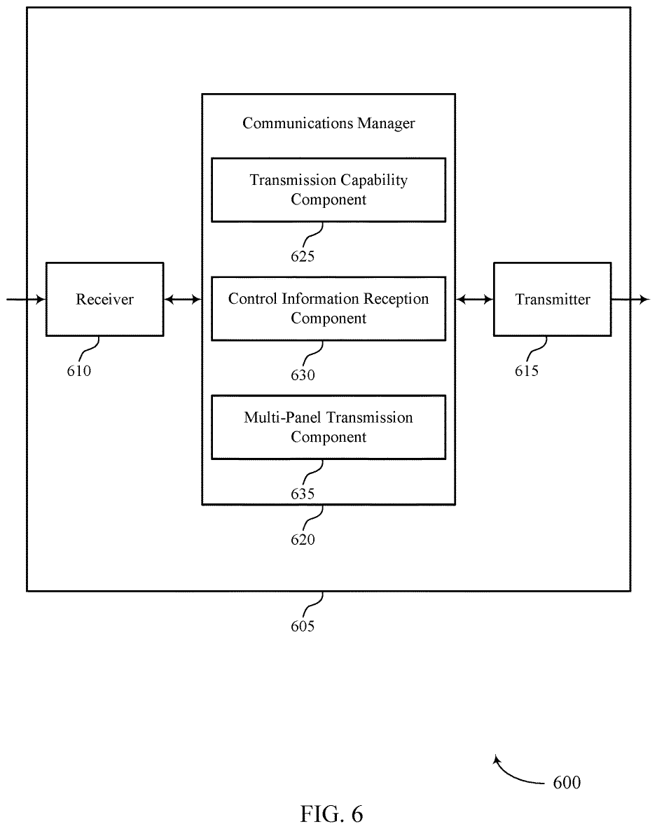

FIG. 6 shows a block diagram 600 of a device 605 that supports concurrent multi-panel transmissions in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to concurrent multi-panel transmissions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to concurrent multi-panel transmissions). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of concurrent multi-panel transmissions as described herein. For example, the communications manager 620 may include a transmission capability component 625, a control information reception component 630, a multi-panel transmission component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The transmission capability component 625 may be configured as or otherwise support a means for transmitting a capability message that indicates a number of layers supported by the UE for concurrent multi-panel transmissions using a set of multiple antenna panels of the UE. The control information reception component 630 may be configured as or otherwise support a means for receiving one or more control messages that indicate scheduling information for multiple uplink messages for transmission by the UE using the set of multiple antenna panels of the UE in accordance with the number of layers supported by the UE for concurrent multi-panel transmissions. The multi-panel transmission component 635 may be configured as or otherwise support a means for transmitting, based on the scheduling information, the multiple uplink messages using the set of multiple antenna panels of the UE in accordance with the number of layers supported by the UE for concurrent multi-panel transmissions.

Additionally or alternatively, the communications manager 620 may support wireless communications at a UE in accordance with examples as disclosed herein. The transmission capability component 625 may be configured as or otherwise support a means for transmitting a capability message that indicates UE support for concurrent multi-panel uplink transmissions using a set of multiple antenna panels of the UE. The control information reception component 630 may be configured as or otherwise support a means for receiving one or more control messages that indicate scheduling information for a first uplink message and a second uplink message for transmission by the UE using the set of multiple antenna panels of the UE, each of the first uplink message and the second uplink message associated with a respective transmission configuration indication state, where the first uplink message and the second uplink message are scheduled in at least partially overlapping time resources. The multi-panel transmission component 635 may be configured as or otherwise support a means for transmitting, based on the scheduling information and via the partially overlapping time resources, the first and second uplink messages using the set of multiple antenna panels of the UE in accordance with the respective transmission configuration indication states.

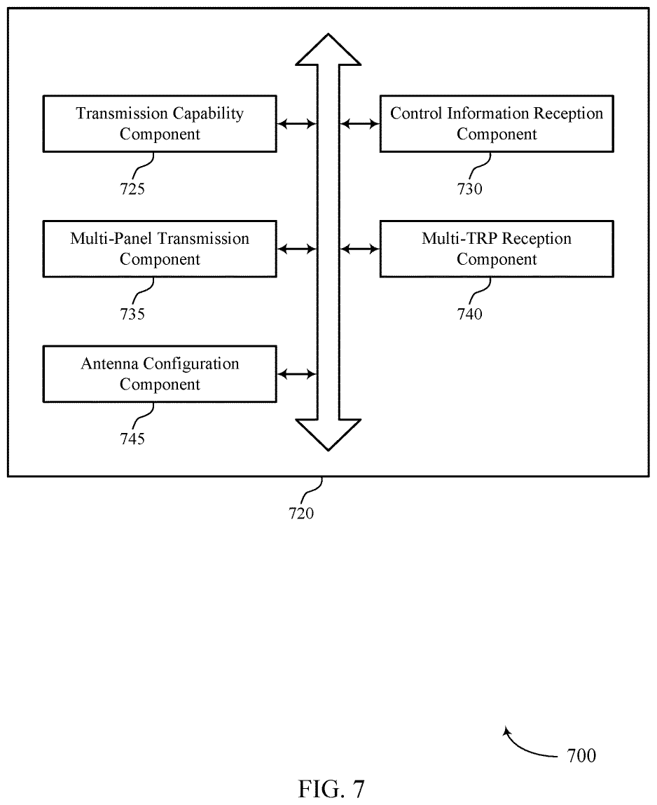

FIG. 7 shows a block diagram 700 of a communications manager 720 that supports concurrent multi-panel transmissions in accordance with aspects of the present disclosure. The communications manager 720 may be an example of aspects of a communications manager 520, a communications manager 620, or both, as described herein. The communications manager 720, or various components thereof, may be an example of means for performing various aspects of concurrent multi-panel transmissions as described herein. For example, the communications manager 720 may include a transmission capability component 725, a control information reception component 730, a multi-panel transmission component 735, a multi-TRP reception component 740, an antenna configuration component 745, or any combination thereof. Each of these components may communicate, directly or indirectly, with one another (e.g., via one or more buses).

The communications manager 720 may support wireless communications at a UE in accordance with examples as disclosed herein. The transmission capability component 725 may be configured as or otherwise support a means for transmitting a capability message that indicates a number of layers supported by the UE for concurrent multi-panel transmissions using a set of multiple antenna panels of the UE. The control information reception component 730 may be configured as or otherwise support a means for receiving one or more control messages that indicate scheduling information for multiple uplink messages for transmission by the UE using the set of multiple antenna panels of the UE in accordance with the number of layers supported by the UE for concurrent multi-panel transmissions. The multi-panel transmission component 735 may be configured as or otherwise support a means for transmitting, based on the scheduling information, the multiple uplink messages using the set of multiple antenna panels of the UE in accordance with the number of layers supported by the UE for concurrent multi-panel transmissions.

In some examples, to support transmitting the multiple uplink messages, the multi-panel transmission component 735 may be configured as or otherwise support a means for transmitting, based on the scheduling information, a first uplink message of the multiple uplink messages using a first antenna panel of the set of multiple antenna panels of the UE in accordance with a first respective number of layers for the first antenna panel. In some examples, to support transmitting the multiple uplink messages, the multi-panel transmission component 735 may be configured as or otherwise support a means for transmitting, based on the scheduling information, a second uplink message of the multiple uplink message using a second antenna panel of the set of multiple antenna panels of the UE in accordance with a second respective number of layers for the second antenna panel.

In some examples, to support transmitting the capability message, the transmission capability component 725 may be configured as or otherwise support a means for transmitting one or more indications of a respective number of layers supported per antenna panel of the set of multiple antenna panels of the UE.

In some examples, a first antenna panel of the set of multiple antenna panels supports a first number of layers and a second antenna panel of the set of multiple antenna panels supports a second number of layers different from the first number of layers.

In some examples, to support transmitting the multiple uplink messages, the multi-panel transmission component 735 may be configured as or otherwise support a means for transmitting, based on the scheduling information, a first uplink message of the multiple uplink messages using a first antenna panel of the set of multiple antenna panels of the UE in accordance with the number of layers. In some examples, to support transmitting the multiple uplink messages, the multi-panel transmission component 735 may be configured as or otherwise support a means for transmitting, based on the scheduling information, a second uplink message of the multiple uplink messages using a second antenna panel of the set of multiple antenna panels of the UE in accordance with the number of layers.

In some examples, to support transmitting the capability message, the transmission capability component 725 may be configured as or otherwise support a means for transmitting one or more indications of a total number of layers supported across all of the set of multiple antenna panels of the UE.

In some examples, to support transmitting the multiple uplink messages, the multi-panel transmission component 735 may be configured as or otherwise support a means for transmitting the multiple uplink messages using at least two different antenna panels of the set of multiple antenna panels of the UE according to one of a spatial division multiplexing scheme, a frequency division multiplexing scheme, or a single frequency network scheme.

In some examples, to support transmitting the multiple uplink messages, the multi-panel transmission component 735 may be configured as or otherwise support a means for transmitting the multiple uplink messages using at least two different antenna panels of the set of multiple antenna panels of the UE, where a first uplink message of the multiple uplink messages at least partially overlaps in time, frequency, or both with a second uplink message of the multiple uplink messages.

In some examples, to support receiving the one or more control messages, the multi-TRP reception component 740 may be configured as or otherwise support a means for receiving, from a first transmission reception point, a first control message indicating first scheduling information for a first uplink message of the multiple uplink messages. In some examples, to support receiving the one or more control messages, the multi-TRP reception component 740 may be configured as or otherwise support a means for receiving, from a second transmission reception point, a second control message indicating second scheduling information for a second uplink message of the multiple uplink messages, where the second uplink message is scheduled via resources that at least partially overlap in time or frequency with the first uplink message.

In some examples, a first antenna panel of the set of multiple antenna panels is associated with a first transmit precoding matrix index (TPMI), a first SRS resource indicator (SRI), and a first transmission configuration indication (TCI) state. In some examples, a second antenna panel of the set of multiple antenna panels is associated with a second TPMI, a second SRI, and a second TCI.

Additionally or alternatively, the communications manager 720 may support wireless communications at a UE in accordance with examples as disclosed herein. In some examples, the transmission capability component 725 may be configured as or otherwise support a means for transmitting a capability message that indicates UE support for concurrent multi-panel uplink transmissions using a set of multiple antenna panels of the UE. In some examples, the control information reception component 730 may be configured as or otherwise support a means for receiving one or more control messages that indicate scheduling information for a first uplink message and a second uplink message for transmission by the UE using the set of multiple antenna panels of the UE, each of the first uplink message and the second uplink message associated with a respective transmission configuration indication state, where the first uplink message and the second uplink message are scheduled in at least partially overlapping time resources. In some examples, the multi-panel transmission component 735 may be configured as or otherwise support a means for transmitting, based on the scheduling information and via the partially overlapping time resources, the first and second uplink messages using the set of multiple antenna panels of the UE in accordance with the respective transmission configuration indication states.

In some examples, to support transmitting the first and second uplink messages, the multi-panel transmission component 735 may be configured as or otherwise support a means for transmitting, based on the scheduling information and via the partially overlapping time resources, a dynamically scheduled uplink shared channel using a first antenna panel of the set of multiple antenna panels of the UE and a configured grant uplink shared channel using a second antenna panel of the set of multiple antenna panels of the UE in accordance with the respective transmission configuration indication states.

In some examples, to support transmitting the first and second uplink messages, the multi-panel transmission component 735 may be configured as or otherwise support a means for transmitting, based on the scheduling information and via the partially overlapping time resources, the first uplink message using a first antenna panel of the set of multiple antenna panels of the UE and the second uplink message using a second antenna panel of the set of multiple antenna panels of the UE in accordance with the respective transmission configuration indication states, where the first and second uplink messages have a same waveform or different waveforms.

In some examples, to support transmitting the first and second uplink messages, the multi-panel transmission component 735 may be configured as or otherwise support a means for transmitting, based on the scheduling information and via the partially overlapping time resources, an uplink shared channel using a first antenna panel of the set of multiple antenna panels of the UE and an uplink control channel message using a second antenna panel of the set of multiple antenna panels of the UE in accordance with the respective transmission configuration indication states.

In some examples, to support transmitting the first and second uplink messages, the multi-panel transmission component 735 may be configured as or otherwise support a means for transmitting, based on the scheduling information and via the partially overlapping time resources, a first uplink control channel using a first antenna panel of the set of multiple antenna panels of the UE and a second uplink control channel message using a second antenna panel of the set of multiple antenna panels of the UE in accordance with the respective transmission configuration indication states.

In some examples, to support transmitting the first and second uplink messages, the multi-panel transmission component 735 may be configured as or otherwise support a means for transmitting, based on the scheduling information and via the partially overlapping time resources, a sounding reference signal using a first antenna panel of the set of multiple antenna panels of the UE and the second uplink message using a second antenna panel of the set of multiple antenna panels of the UE in accordance with the respective transmission configuration indication states, where the second uplink message includes one of an uplink control channel or an uplink shared channel.

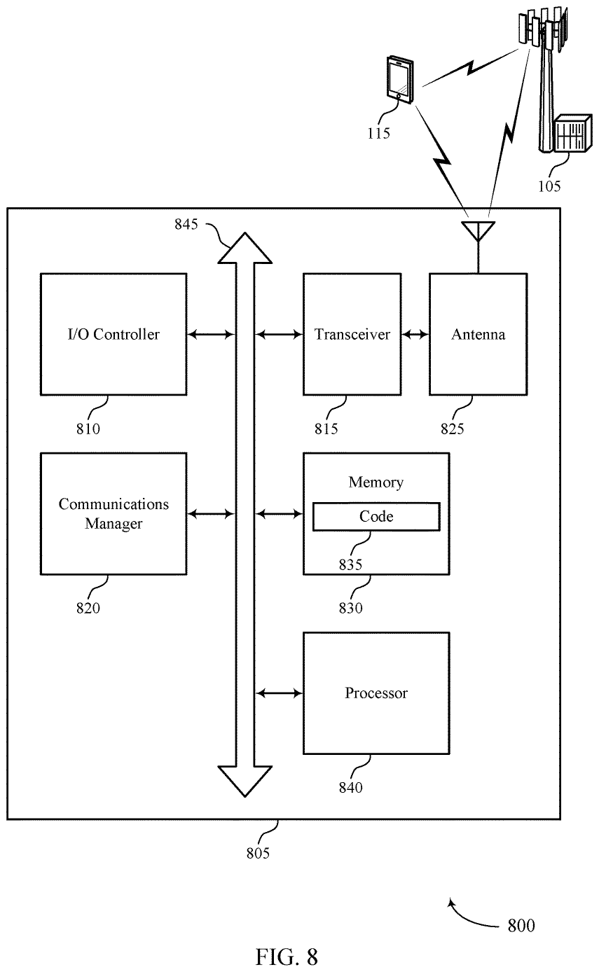

FIG. 8 shows a diagram of a system 800 including a device 805 that supports concurrent multi-panel transmissions in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof.

The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting concurrent multi-panel transmissions). For example, the device 805 or a component of the device 805 may include a processor 840 and memory 830 coupled to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for transmitting a capability message that indicates a number of layers supported by the UE for concurrent multi-panel transmissions using a set of multiple antenna panels of the UE. The communications manager 820 may be configured as or otherwise support a means for receiving one or more control messages that indicate scheduling information for multiple uplink messages for transmission by the UE using the set of multiple antenna panels of the UE in accordance with the number of layers supported by the UE for concurrent multi-panel transmissions. The communications manager 820 may be configured as or otherwise support a means for transmitting, based on the scheduling information, the multiple uplink messages using the set of multiple antenna panels of the UE in accordance with the number of layers supported by the UE for concurrent multi-panel transmissions.

Additionally or alternatively, the communications manager 820 may support wireless communications at a UE in accordance with examples as disclosed herein. For example, the communications manager 820 may be configured as or otherwise support a means for transmitting a capability message that indicates UE support for concurrent multi-panel uplink transmissions using a set of multiple antenna panels of the UE. The communications manager 820 may be configured as or otherwise support a means for receiving one or more control messages that indicate scheduling information for a first uplink message and a second uplink message for transmission by the UE using the set of multiple antenna panels of the UE, each of the first uplink message and the second uplink message associated with a respective transmission configuration indication state, where the first uplink message and the second uplink message are scheduled in at least partially overlapping time resources. The communications manager 820 may be configured as or otherwise support a means for transmitting, based on the scheduling information and via the partially overlapping time resources, the first and second uplink messages using the set of multiple antenna panels of the UE in accordance with the respective transmission configuration indication states.

By including or configuring the communications manager 820 in accordance with examples as described herein, the device 805 may support techniques for improved MIMO communication reliability, reduced latency, improved user experience related to reduced processing, reduced power consumption, more efficient utilization of communication resources via concurrent multi-panel transmissions, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of concurrent multi-panel transmissions as described herein, or the processor 840 and the memory 830 may be otherwise configured to perform or support such operations.

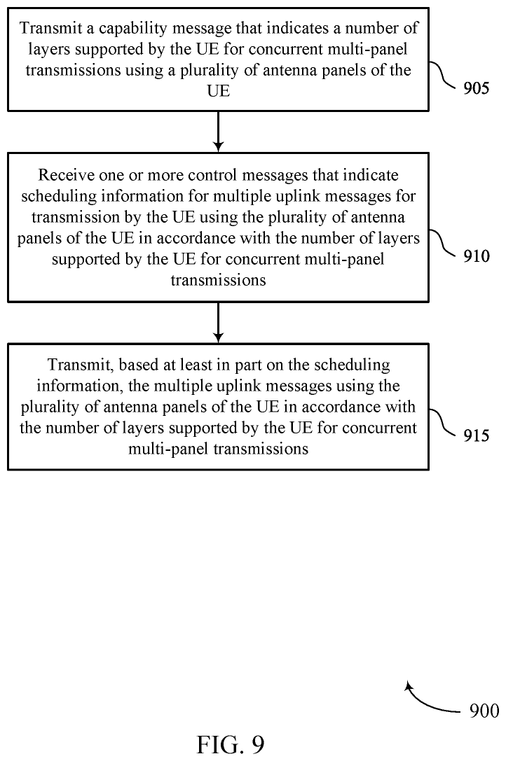

FIG. 9 shows a flowchart illustrating a method 900 that supports concurrent multi-panel transmissions in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 905, the method may include transmitting a capability message that indicates a number of layers supported by the UE for concurrent multi-panel transmissions using a set of multiple antenna panels of the UE. The operations of 905 may be performed in accordance with examples as disclosed herein. In some examples, aspects of the operations of 905 may be performed by a transmission capability component 725 as described with reference to FIG. 7.

At 910, the method may include receiving one or more control messages that indicate scheduling information for multiple uplink messages for transmission by the UE using the set of multiple antenna panels of the UE in accordance with the number of layers supported by the UE for concurrent multi-panel transmissions. The operations of 910 may be performed in accordance with examples as disclosed herein. In some examples, aspects of the operations of 910 may be performed by a control information reception component 730 as described with reference to FIG. 7.

At 915, the method may include transmitting, based on the scheduling information, the multiple uplink messages using the set of multiple antenna panels of the UE in accordance with the number of layers supported by the UE for concurrent multi-panel transmissions. The operations of 915 may be performed in accordance with examples as disclosed herein. In some examples, aspects of the operations of 915 may be performed by a multi-panel transmission component 735 as described with reference to FIG. 7.

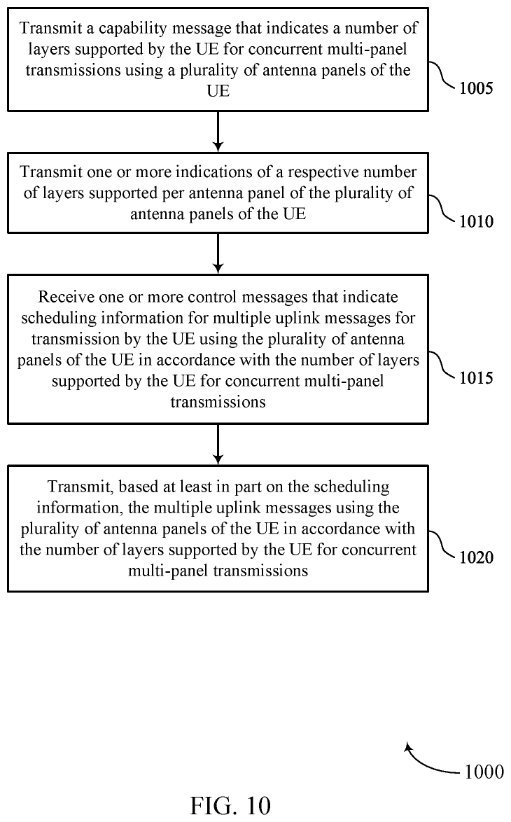

FIG. 10 shows a flowchart illustrating a method 1000 that supports concurrent multi-panel transmissions in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1005, the method may include transmitting a capability message that indicates a number of layers supported by the UE for concurrent multi-panel transmissions using a set of multiple antenna panels of the UE. The operations of 1005 may be performed in accordance with examples as disclosed herein. In some examples, aspects of the operations of 1005 may be performed by a transmission capability component 725 as described with reference to FIG. 7.

At 1010, the method may include transmitting one or more indications of a respective number of layers supported per antenna panel of the set of multiple antenna panels of the UE. The operations of 1010 may be performed in accordance with examples as disclosed herein. In some examples, aspects of the operations of 1010 may be performed by a transmission capability component 725 as described with reference to FIG. 7.

At 1015, the method may include receiving one or more control messages that indicate scheduling information for multiple uplink messages for transmission by the UE using the set of multiple antenna panels of the UE in accordance with the number of layers supported by the UE for concurrent multi-panel transmissions. The operations of 1015 may be performed in accordance with examples as disclosed herein. In some examples, aspects of the operations of 1015 may be performed by a control information reception component 730 as described with reference to FIG. 7.

At 1020, the method may include transmitting, based on the scheduling information, the multiple uplink messages using the set of multiple antenna panels of the UE in accordance with the number of layers supported by the UE for concurrent multi-panel transmissions. The operations of 1020 may be performed in accordance with examples as disclosed herein. In some examples, aspects of the operations of 1020 may be performed by a multi-panel transmission component 735 as described with reference to FIG. 7.

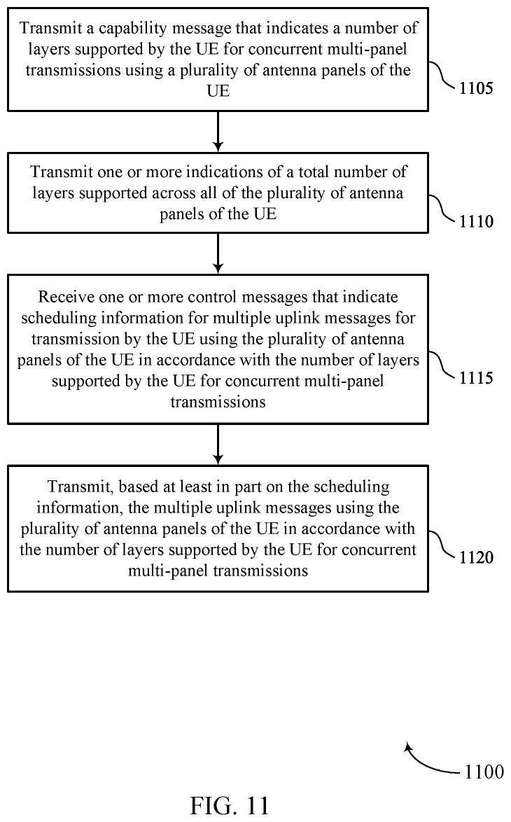

FIG. 11 shows a flowchart illustrating a method 1100 that supports concurrent multi-panel transmissions in accordance with aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1105, the method may include transmitting a capability message that indicates a number of layers supported by the UE for concurrent multi-panel transmissions using a set of multiple antenna panels of the UE. The operations of 1105 may be performed in accordance with examples as disclosed herein. In some examples, aspects of the operations of 1105 may be performed by a transmission capability component 725 as described with reference to FIG. 7.

At 1110, the method may include transmitting one or more indications of a total number of layers supported across all of the set of multiple antenna panels of the UE. The operations of 1110 may be performed in accordance with examples as disclosed herein. In some examples, aspects of the operations of 1110 may be performed by a transmission capability component 725 as described with reference to FIG. 7.

At 1115, the method may include receiving one or more control messages that indicate scheduling information for multiple uplink messages for transmission by the UE using the set of multiple antenna panels of the UE in accordance with the number of layers supported by the UE for concurrent multi-panel transmissions. The operations of 1115 may be performed in accordance with examples as disclosed herein. In some examples, aspects of the operations of 1115 may be performed by a control information reception component 730 as described with reference to FIG. 7.

At 1120, the method may include transmitting, based on the scheduling information, the multiple uplink messages using the set of multiple antenna panels of the UE in accordance with the number of layers supported by the UE for concurrent multi-panel transmissions. The operations of 1120 may be performed in accordance with examples as disclosed herein. In some examples, aspects of the operations of 1120 may be performed by a multi-panel transmission component 735 as described with reference to FIG. 7.

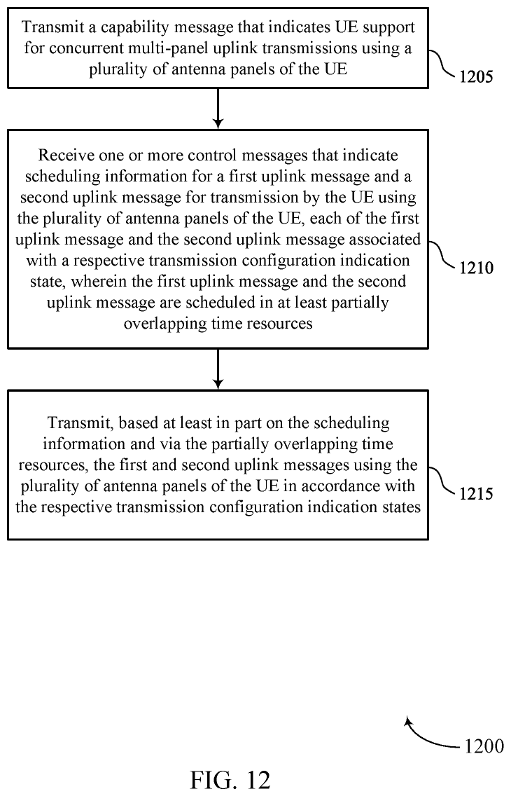

FIG. 12 shows a flowchart illustrating a method 1200 that supports concurrent multi-panel transmissions in accordance with aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1205, the method may include transmitting a capability message that indicates UE support for concurrent multi-panel uplink transmissions using a set of multiple antenna panels of the UE. The operations of 1205 may be performed in accordance with examples as disclosed herein. In some examples, aspects of the operations of 1205 may be performed by a transmission capability component 725 as described with reference to FIG. 7.

At 1210, the method may include receiving one or more control messages that indicate scheduling information for a first uplink message and a second uplink message for transmission by the UE using the set of multiple antenna panels of the UE, each of the first uplink message and the second uplink message associated with a respective transmission configuration indication state, where the first uplink message and the second uplink message are scheduled in at least partially overlapping time resources. The operations of 1210 may be performed in accordance with examples as disclosed herein. In some examples, aspects of the operations of 1210 may be performed by a control information reception component 730 as described with reference to FIG. 7.

At 1215, the method may include transmitting, based on the scheduling information and via the partially overlapping time resources, the first and second uplink messages using the set of multiple antenna panels of the UE in accordance with the respective transmission configuration indication states. The operations of 1215 may be performed in accordance with examples as disclosed herein. In some examples, aspects of the operations of 1215 may be performed by a multi-panel transmission component 735 as described with reference to FIG. 7.

The following provides an overview of aspects of the present disclosure:
Aspect 1: A method for wireless communications at a UE, comprising:
   transmitting a capability message that indicates a number of layers supported by the UE for concurrent multi-panel transmissions using a plurality of antenna panels of the UE;
   receiving one or more control messages that indicate scheduling information for multiple uplink messages for transmission by the UE using the plurality of antenna panels of the UE in accordance with the number of layers supported by the UE for concurrent multi-panel transmissions; and transmitting, based at least in part on the scheduling information, the multiple uplink messages using the plurality of antenna panels of the UE in accordance with the number of layers supported by the UE for concurrent multi-panel transmissions.
Aspect 2: The method of aspect 1, wherein the number of layers corresponds to respective supported layers for each antenna panel of the plurality of antenna panels of the UE, wherein transmitting the multiple uplink messages comprises: transmitting, based at least in part on the scheduling information, a first uplink message of the multiple uplink messages using a first antenna panel of the plurality of antenna panels of the UE in accordance with a first respective number of layers for the first antenna panel; and transmitting, based at least in part on the scheduling information, a second uplink message of the multiple uplink message using a second antenna panel of the plurality of antenna panels of the UE in accordance with a second respective number of layers for the second antenna panel.
Aspect 3: The method of any of aspects 1 through 2, wherein transmitting the capability message comprises: transmitting one or more indications of a respective number of layers supported per antenna panel of the plurality of antenna panels of the UE

Aspect 4: The method of aspect 3, wherein a first antenna panel of the plurality of antenna panels supports a first number of layers and a second antenna panel of the plurality of antenna panels supports a second number of layers different from the first number of layers.

Aspect 5: The method of any of aspects 1 through 4, wherein the number of layers corresponds to total supported layers across all of the plurality of antenna panels of the UE, wherein transmitting the multiple uplink messages comprises: transmitting, based at least in part on the scheduling information, a first uplink message of the multiple uplink messages using a first antenna panel of the plurality of antenna panels of the UE in accordance with the number of layers; and transmitting, based at least in part on the scheduling information, a second uplink message of the multiple uplink messages using a second antenna panel of the plurality of antenna panels of the UE in accordance with the number of layers.

Aspect 6: The method of any of aspects 1 through 5, wherein transmitting the capability message comprises: transmitting one or more indications of a total number of layers supported across all of the plurality of antenna panels of the UE.

Aspect 7: The method of aspect 6, wherein transmitting the multiple uplink messages comprises: transmitting the multiple uplink messages using at least two different antenna panels of the plurality of antenna panels of the UE according to one of a spatial division multiplexing scheme, a frequency division multiplexing scheme, or a single frequency network scheme.

Aspect 8: The method of any of aspects 6 through 7, wherein transmitting the multiple uplink messages comprises: transmitting the multiple uplink messages using at least two different antenna panels of the plurality of antenna panels of the UE, wherein a first uplink message of the multiple uplink messages at least partially overlaps in time, frequency, or both with a second uplink message of the multiple uplink messages.

Aspect 9: The method of any of aspects 1 through 8, wherein receiving the one or more control messages comprises: receiving, from a first transmission reception point, a first control message indicating first scheduling information for a first uplink message of the multiple uplink messages; and receiving, from a second transmission reception point, a second control message indicating second scheduling information for a second uplink message of the multiple uplink messages, wherein the second uplink message is scheduled via resources that at least partially overlap in time or frequency with the first uplink message.

Aspect 10: The method of any of aspects 1 through 9, wherein a first antenna panel of the plurality of antenna panels is associated with a first TPMI, a first SRI, and a first TCI state; and a second antenna panel of the plurality of antenna panels is associated with a second TPMI, a second SRI, and a second TCI.

Aspect 11: A method for wireless communications at a UE, comprising: transmitting a capability message that indicates UE support for concurrent multi-panel uplink transmissions using a plurality of antenna panels of the UE; receiving one or more control messages that indicate scheduling information for a first uplink message and a second uplink message for transmission by the UE using the plurality of antenna panels of the UE, each of the first uplink message and the second uplink message associated with a respective transmission configuration indication state, wherein the first uplink message and the second uplink message are scheduled in at least partially overlapping time resources; and transmitting, based at least in part on the scheduling information and via the partially overlapping time resources, the first and second uplink messages using the plurality of antenna panels of the UE in accordance with the respective transmission configuration indication states.

Aspect 12: The method of aspect 11, wherein transmitting the first and second uplink messages comprises: transmitting, based at least in part on the scheduling information and via the partially overlapping time resources, a dynamically scheduled uplink shared channel using a first antenna panel of the plurality of antenna panels of the UE and a configured grant uplink shared channel using a second antenna panel of the plurality of antenna panels of the UE in accordance with the respective transmission configuration indication states.

Aspect 13: The method of any of aspects 11 through 12, wherein transmitting the first and second uplink messages comprises: transmitting, based at least in part on the scheduling information and via the partially overlapping time resources, the first uplink message using a first antenna panel of the plurality of antenna panels of the UE and the second uplink message using a second antenna panel of the plurality of antenna panels of the UE in accordance with the respective transmission configuration indication states, wherein the first and second uplink messages have a same waveform or different waveforms.

Aspect 14: The method of any of aspects 11 through 13, wherein transmitting the first and second uplink messages comprises: transmitting, based at least in part on the scheduling information and via the partially overlapping time resources, an uplink shared channel using a first antenna panel of the plurality of antenna panels of the UE and an uplink control channel message using a second antenna panel of the plurality of antenna panels of the UE in accordance with the respective transmission configuration indication states.

Aspect 15: The method of any of aspects 11 through 14, wherein transmitting the first and second uplink messages comprises: transmitting, based at least in part on the scheduling information and via the partially overlapping time resources, a first uplink control channel using a first antenna panel of the plurality of antenna panels of the UE and a second uplink control channel message using a second antenna panel of the plurality of antenna panels of the UE in accordance with the respective transmission configuration indication states.

Aspect 16: The method of any of aspects 11 through 15, wherein transmitting the first and second uplink messages comprises: transmitting, based at least in part on the scheduling information and via the partially overlapping time resources, a sounding reference signal using a first antenna panel of the plurality of antenna panels of the UE and the second uplink message using a second antenna panel of the plurality of antenna panels of the UE in accordance with the respective transmission configuration indication states, wherein the second uplink message comprises one of an uplink control channel or an uplink shared channel.

Aspect 17: An apparatus for wireless communications at a UE, comprising a processor; memory coupled with the processor; and instructions stored in the memory and executable by the processor to cause the apparatus to perform a method of any of aspects 1 through 10.

Aspect 18: An apparatus for wireless communications at a UE, comprising at least one means for performing a method of any of aspects 1 through 10.

Aspect 19: A non-transitory computer-readable medium storing code for wireless communications at a UE, the code comprising instructions executable by a processor to perform a method of any of aspects 1 through 10.

Aspect 20: An apparatus for wireless communications at a UE, comprising a processor; memory coupled with the processor; and instructions stored in the memory and executable by the processor to cause the apparatus to perform a method of any of aspects 11 through 16.

Aspect 21: An apparatus for wireless communications at a UE, comprising at least one means for performing a method of any of aspects 11 through 16.

Aspect 22: A non-transitory computer-readable medium storing code for wireless communications at a UE, the code comprising instructions executable by a processor to perform a method of any of aspects 11 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
transmitting a capability message that indicates a number of layers supported by the UE for concurrent multi-panel transmissions using a plurality of antenna panels of the UE;
receiving one or more control messages that indicate scheduling information for multiple uplink messages for transmission by the UE using the plurality of antenna panels of the UE in accordance with the number of layers supported by the UE for concurrent multi-panel transmissions; and
transmitting, based at least in part on the scheduling information, the multiple uplink messages using the plurality of antenna panels of the UE in accordance with the number of layers supported by the UE for concurrent multi-panel transmissions.

2. The method of claim 1, wherein the number of layers corresponds to respective supported layers for each antenna panel of the plurality of antenna panels of the UE, wherein transmitting the multiple uplink messages comprises:
transmitting, based at least in part on the scheduling information, a first uplink message of the multiple uplink messages using a first antenna panel of the plurality of antenna panels of the UE in accordance with a first respective number of layers for the first antenna panel; and
transmitting, based at least in part on the scheduling information, a second uplink message of the multiple uplink message using a second antenna panel of the plurality of antenna panels of the UE in accordance with a second respective number of layers for the second antenna panel.

3. The method of claim 1, wherein transmitting the capability message comprises:
transmitting one or more indications of a respective number of layers supported per antenna panel of the plurality of antenna panels of the UE.

4. The method of claim 3, wherein a first antenna panel of the plurality of antenna panels supports a first number of layers and a second antenna panel of the plurality of antenna panels supports a second number of layers different from the first number of layers.

5. The method of claim 1, wherein the number of layers corresponds to total supported layers across all of the plurality of antenna panels of the UE, wherein transmitting the multiple uplink messages comprises:
transmitting, based at least in part on the scheduling information, a first uplink message of the multiple uplink messages using a first antenna panel of the plurality of antenna panels of the UE in accordance with the number of layers; and
transmitting, based at least in part on the scheduling information, a second uplink message of the multiple uplink messages using a second antenna panel of the plurality of antenna panels of the UE in accordance with the number of layers.

6. The method of claim 1, wherein transmitting the capability message comprises:
transmitting one or more indications of a total number of layers supported across all of the plurality of antenna panels of the UE.

7. The method of claim 6, wherein transmitting the multiple uplink messages comprises:
transmitting the multiple uplink messages using at least two different antenna panels of the plurality of antenna panels of the UE according to one of a spatial division multiplexing scheme, a frequency division multiplexing scheme, or a single frequency network scheme.

8. The method of claim 6, wherein transmitting the multiple uplink messages comprises:
transmitting the multiple uplink messages using at least two different antenna panels of the plurality of antenna panels of the UE, wherein a first uplink message of the multiple uplink messages at least partially overlaps in time, frequency, or both with a second uplink message of the multiple uplink messages.

9. The method of claim 1, wherein receiving the one or more control messages comprises:
receiving, from a first transmission reception point, a first control message indicating first scheduling information for a first uplink message of the multiple uplink messages; and
receiving, from a second transmission reception point, a second control message indicating second scheduling information for a second uplink message of the multiple uplink messages, wherein the second uplink message is scheduled via resources that at least partially overlap in time or frequency with the first uplink message.

10. The method of claim 1, wherein:
a first antenna panel of the plurality of antenna panels is associated with a first transmit precoding matrix index (TPMI), a first sounding reference signal (SRS) resource indicator (SRI), and a first transmission configuration indication (TCI) state; and
a second antenna panel of the plurality of antenna panels is associated with a second TPMI, a second SRI, and a second TCI.

11. A method for wireless communications at a user equipment (UE), comprising:
transmitting a capability message that indicates UE support for concurrent multi-panel uplink transmissions using a plurality of antenna panels of the UE;
receiving one or more control messages that indicate scheduling information for a first uplink message and a second uplink message for transmission by the UE using the plurality of antenna panels of the UE, each of the first uplink message and the second uplink message associated with a respective transmission configuration indication state, wherein the first uplink message and the second uplink message are scheduled in at least partially overlapping time resources; and
transmitting, based at least in part on the scheduling information and via the partially overlapping time resources, the first and second uplink messages using the plurality of antenna panels of the UE in accordance with the respective transmission configuration indication states.

12. The method of claim 11, wherein transmitting the first and second uplink messages comprises:
transmitting, based at least in part on the scheduling information and via the partially overlapping time resources, a dynamically scheduled uplink shared channel using a first antenna panel of the plurality of antenna panels of the UE and a configured grant uplink shared channel using a second antenna panel of the plurality of antenna panels of the UE in accordance with the respective transmission configuration indication states.

13. The method of claim 11, wherein transmitting the first and second uplink messages comprises:
transmitting, based at least in part on the scheduling information and via the partially overlapping time resources, the first uplink message using a first antenna panel of the plurality of antenna panels of the UE and the second uplink message using a second antenna panel of the plurality of antenna panels of the UE in accordance with the respective transmission configuration indication states, wherein the first and second uplink messages have a same waveform or different waveforms.

14. The method of claim 11, wherein transmitting the first and second uplink messages comprises:
transmitting, based at least in part on the scheduling information and via the partially overlapping time resources, an uplink shared channel using a first antenna panel of the plurality of antenna panels of the UE and an uplink control channel message using a second antenna panel of the plurality of antenna panels of the UE in accordance with the respective transmission configuration indication states.

15. The method of claim 11, wherein transmitting the first and second uplink messages comprises:
transmitting, based at least in part on the scheduling information and via the partially overlapping time resources, a first uplink control channel using a first antenna panel of the plurality of antenna panels of the UE and a second uplink control channel message using a second antenna panel of the plurality of antenna panels of the UE in accordance with the respective transmission configuration indication states.

16. The method of claim 11, wherein transmitting the first and second uplink messages comprises:
transmitting, based at least in part on the scheduling information and via the partially overlapping time resources, a sounding reference signal using a first antenna panel of the plurality of antenna panels of the UE and the second uplink message using a second antenna panel of the plurality of antenna panels of the UE in accordance with the respective transmission configuration indication states, wherein the second uplink message comprises one of an uplink control channel or an uplink shared channel.

17. An apparatus for wireless communications at a user equipment (UE), comprising:
a processor;
memory coupled with the processor; and
instructions stored in the memory and executable by the processor to cause the apparatus to:
transmit a capability message that indicates a number of layers supported by the UE for concurrent multi-panel transmissions using a plurality of antenna panels of the UE;
receive one or more control messages that indicate scheduling information for multiple uplink messages for transmission by the UE using the plurality of antenna panels of the UE in accordance with the number of layers supported by the UE for concurrent multi-panel transmissions; and
transmit, based at least in part on the scheduling information, the multiple uplink messages using the plurality of antenna panels of the UE in accordance with the number of layers supported by the UE for concurrent multi-panel transmissions.

18. The apparatus of claim 17, wherein the instructions to transmit the multiple uplink messages are executable by the processor to cause the apparatus to:
transmit, based at least in part on the scheduling information, a first uplink message of the multiple uplink messages using a first antenna panel of the plurality of antenna panels of the UE in accordance with a first respective number of layers for the first antenna panel; and
transmit, based at least in part on the scheduling information, a second uplink message of the multiple uplink message using a second antenna panel of the plurality of antenna panels of the UE in accordance with a second respective number of layers for the second antenna panel.

19. The apparatus of claim 17, wherein the instructions to transmit the capability message are executable by the processor to cause the apparatus to:
transmit one or more indications of a respective number of layers supported per antenna panel of the plurality of antenna panels of the UE.

20. The apparatus of claim 19, wherein a first antenna panel of the plurality of antenna panels supports a first number of layers and a second antenna panel of the plurality of antenna panels supports a second number of layers different from the first number of layers.

21. The apparatus of claim 17, wherein the instructions to transmit the multiple uplink messages are executable by the processor to cause the apparatus to:
transmit, based at least in part on the scheduling information, a first uplink message of the multiple uplink messages using a first antenna panel of the plurality of antenna panels of the UE in accordance with the number of layers; and
transmit, based at least in part on the scheduling information, a second uplink message of the multiple uplink messages using a second antenna panel of the plurality of antenna panels of the UE in accordance with the number of layers.

22. The apparatus of claim 17, wherein the instructions to transmit the capability message are executable by the processor to cause the apparatus to:
transmit one or more indications of a total number of layers supported across all of the plurality of antenna panels of the UE.

23. The apparatus of claim 22, wherein the instructions to transmit the multiple uplink messages are executable by the processor to cause the apparatus to:
transmit the multiple uplink messages using at least two different antenna panels of the plurality of antenna panels of the UE according to one of a spatial division multiplexing scheme, a frequency division multiplexing scheme, or a single frequency

24. The apparatus of claim 22, wherein the instructions to transmit the multiple uplink messages are executable by the processor to cause the apparatus to:
transmit the multiple uplink messages using at least two different antenna panels of the plurality of antenna panels of the UE, wherein a first uplink message of the multiple uplink messages at least partially overlaps in time, frequency, or both with a second uplink message of the multiple uplink messages.

25. The apparatus of claim 17, wherein the instructions to receive the one or more control messages are executable by the processor to cause the apparatus to:
receive, from a first transmission reception point, a first control message indicating first scheduling information for a first uplink message of the multiple uplink messages; and
receive, from a second transmission reception point, a second control message indicating second scheduling information for a second uplink message of the multiple uplink messages, wherein the second uplink message is scheduled via resources that at least partially overlap in time or frequency with the first uplink message.

26. An apparatus for wireless communications at a user equipment (UE), comprising:
a processor;
memory coupled with the processor; and
instructions stored in the memory and executable by the processor to cause the apparatus to:
transmit a capability message that indicates UE support for concurrent multi-panel uplink transmissions using a plurality of antenna panels of the UE;
receive one or more control messages that indicate scheduling information for a first uplink message and a second uplink message for transmission by the UE using the plurality of antenna panels of the UE, each of the first uplink message and the second uplink message associated with a respective transmission configuration indication state, wherein the first uplink message and the second uplink message are scheduled in at least partially overlapping time resources; and
transmit, based at least in part on the scheduling information and via the partially overlapping time resources, the first and second uplink messages using the plurality of antenna panels of the UE in accordance with the respective transmission configuration indication states.

27. The apparatus of claim 26, wherein the instructions to transmit the first and second uplink messages are executable by the processor to cause the apparatus to:
transmit, based at least in part on the scheduling information and via the partially overlapping time resources, a dynamically scheduled uplink shared channel using a first antenna panel of the plurality of antenna panels of the UE and a configured grant uplink shared channel using a second antenna panel of the plurality of antenna panels of the UE in accordance with the respective transmission configuration indication states.

28. The apparatus of claim 26, wherein the instructions to transmit the first and second uplink messages are executable by the processor to cause the apparatus to:
transmit, based at least in part on the scheduling information and via the partially overlapping time resources, an uplink shared channel using a first antenna panel of the plurality of antenna panels of the UE and an uplink control channel message using a second antenna panel of the plurality of antenna panels of the UE in accordance with the respective transmission configuration indication states.

29. The apparatus of claim 26, wherein the instructions to transmit the first and second uplink messages are executable by the processor to cause the apparatus to:
transmit, based at least in part on the scheduling information and via the partially overlapping time resources, a first uplink control channel using a first antenna panel of the plurality of antenna panels of the UE and a second uplink control channel message using a second antenna panel of the plurality of antenna panels of the UE in accordance with the respective transmission configuration indication states.

30. The apparatus of claim 26, wherein the instructions to transmit the first and second uplink messages are executable by the processor to cause the apparatus to:
transmit, based at least in part on the scheduling information and via the partially overlapping time resources, a sounding reference signal using a first antenna panel of the plurality of antenna panels of the UE and the second uplink message using a second antenna panel of the plurality of antenna panels of the UE in accordance with the respective transmission configuration indication states, wherein the second uplink message comprises one of an uplink control channel or an uplink shared channel.
